(19) United States
(12) Patent Application Publication
(10) Pub. No.: US 2006/0059248 A1
(43) Pub. Date: Mar. 16, 2006

(54) Peer-to-peer-type content distribution system

(76) Inventor: Yasushi Ikeda, Neyagawa-shi (JP)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(21) Appl. No.: 11/186,659

(22) Filed: Jul. 21, 2005

(30) Foreign Application Priority Data
Aug. 31, 2004 (JP) 2004-251541

(51) Int. Cl. G06F 15/16

(52) U.S. Cl. 709/219

(57) ABSTRACT

The system of the present invention includes a number of dynamic peers DP between which content items are exchanged, and a center server CS for controlling the exchange of content items. Each dynamic peer DP sends the operation status thereof to the center server CS, and the center server CS calculates and registers the load on the dynamic peer DP based on the operation status. Each dynamic peer DP obtains a content list from the center server CS, searches for other dynamic peers DP having the desired content item stored therein, and downloads the content item from one of the dynamic peers DP with the lowest load. The system further includes a static peer SP for uploading, to the dynamic peers DP, new content items that have not yet been circulating among the dynamic peers DP. Thus, content items originate from the static peer SP, and are then exchanged between the dynamic peers DP.

### BACKGROUND OF THE INVENTION

1. Field of the Invention

The present invention relates to a peer-to-peer-type content distribution system, and more particularly to a hybrid-type content distribution system using a center server.

2. Description of the Related Art

In a conventional client-server-type content distribution system, content items are stored in the server and are sent to clients as requested by the clients. With this system, however, it is necessary to upgrade the server as the number of clients increases, and the management and maintenance costs will inevitably increase.

In a peer-to-peer-type content distribution system, which has been popular in recent years, content items are exchanged between peers, and the file transfer loads are distributed among different peers. Therefore, with this system, content items can be distributed among a much larger number of peers (clients) as compared with the client-server-type content distribution system.

However, with the peer-to-peer-type content distribution systems currently available, it is difficult to keep track of, and control, how content items are exchanged and used, and therefore users of these systems may infringe the copyrights of content items being exchanged. “Gnutella” and “Winny” are known content distribution systems of a pure peer-to-peer type using no center server, and they have both raised serious copyright issues.

“Napster” is a known content distribution system of a peer-to-peer type using a center server. A system of this type is also called a “hybrid-type content distribution system” because it is a mix of a peer-to-peer system and a client-server system.

### SUMMARY OF THE INVENTION

It is therefore an object of the present invention to provide a peer-to-peer-type content distribution system with copyright protection capabilities. It is another object of the present invention to provide a peer-to-peer-type content distribution system in which file transfer loads are distributed.

A peer-to-peer-type content distribution system of the present invention includes a center server and a plurality of first peers (dynamic pees) connected to the center server. The center server includes: a global storage section for storing content information regarding particulars and a location of each content item stored in each first peer and load information regarding a load on the first peer; a content information registration section for registering the content information received from the first peer in the global storage section; a load information registration section for registering, in the global storage section, the load information of the first peer according to an operation status received from the first peer; and an information returning section for returning, in response to a request from a first peer, the content information and the load information to the first peer. Each first peer includes: a local storage section for storing a content item; a section for obtaining the content information and the load information from the center server; a section for selecting one or more sender peers, being one or more of the plurality of first peers, having a desired content item stored therein based on the obtained content information, and for further selecting one sender peer with a lowest load, from among the selected one or more sender peers, based on the obtained load information; a section for requesting the selected sender peer to send the desired content item and downloading the desired content item from the selected sender peer; a section for registering the downloaded content item in the local storage section; a section for sending content information of the registered content item to the center server; an operation status notification section for sending an operation status of the first peer to the center server; and a section for uploading a desired content item to other peers in response to requests from the other peers.

In the system of the present invention, the center server collects content information from the first peers, and the collected content information can be sent to a first peer in response to a request from the first peer. Therefore, each first peer can determine which other first peers have a desired content item stored therein. Thus, content items can be exchanged between the first peers. Since the center server collects the operation status information of the first peers, content items can be lawfully exchanged while protecting the copyrights thereof. The load information of each first peer can be sent from the center server to other first peers. Therefore, each first peer can determine a first peer with the lowest load as a sender, and the first peer can download a desired content item from the sender peer of the lowest load. As a result, the file transfer loads for exchanging content items among various peers are distributed among the peers.

While a sender peer with the lowest load is selected and a requesting peer downloads a content item from the selected sender peer in the system as described above, the requesting peer may alternatively download a desired content item from a sender peer that is selected based simply on the operation status. Where a sender peer is selected based on the load information, a requesting peer may alternatively select a peer with the nth lowest load (n is a natural number other than 1) as the sender peer, instead of selecting the peer with the lowest load. Specifically, a requesting peer may select a peer with as low a load as possible based not only on the load information but also on the operation status, for example.

Alternatively, a peer with the lowest load may be selected by the center server instead of a requesting peer. Therefore, “the first peer selecting a sender peer” as used herein can include a case where the center server selects one sender peer with the lowest load based on the load information and notifies the first peer of the selected sender peer, in response to which the first peer selects the sender peer, which has already been selected by the center server.

Preferably, the peer-to-peer-type content distribution system further includes a second peer (static peer) connected to the center server. The second peer includes: a local storage section for storing a content item; a section for registering a content item in the local storage section; a section for sending content information of the registered content item to the center server; an operation status notification section for sending an operation status of the second peer to the center server; and a section for uploading a desired content item to a requesting first peer in response to a request from the first peer. The content information registration section registers the content information sent from the second peer in the global storage section. The load information registration section registers load information in the global storage section according to the operation status sent from the second peer.

In such a case, a new content item can be uploaded to the second peer, and the new content item can thereafter be sent to the first peers from the second peer.

Preferably, the content information of a content item includes meta information regarding particulars of the content item and location information regarding a location of the content item. The location information includes identification information regarding an identification of each peer having the content item stored therein and load information regarding a load on the peer.

In such a case, since the load information of a sender peer is added to the content information, the first peer can select a sender peer with the lowest load by obtaining the content information.

A center server of the present invention is the center server used in the peer-to-peer-type content distribution system set forth above. A dynamic peer of the present invention is the first peer used in the peer-to-peer-type content distribution system set forth above. A static peer of the present invention is the second peer used in the peer-to-peer-type content distribution system set forth above. A peer-to-peer-type content distribution method is an operation method of the peer-to-peer-type content distribution system set forth above. A content distribution control method of the present invention is an operation method of the center server. A computer program for use in a center server of the present invention is a computer program for operating the center server. A computer program for use in a dynamic peer of the present invention is a computer program for operating the dynamic peer. A computer program for use in a static peer of the present invention is a computer program for operating the static peer.

### BRIEF DESCRIPTION OF THE DRAWINGS

FIG. 1 is a network diagram showing a general configuration of a peer-to-peer-type content distribution system according to an embodiment of the present invention.

FIG. 2 is a functional block diagram showing a specific configuration of the peer-to-peer-type content distribution system shown in FIG. 1.

FIG. 3 shows the data structure of a record in a content management database shown in FIG. 2.

FIG. 4 shows an example of the content management database shown in FIG. 2.

FIG. 5 shows an example of a local database shown in FIG. 2.

FIG. 6 shows the data structure of a record in a peer operation status database shown in FIG. 2.

FIG. 7 shows the data structure of a record in a peer load management database shown in FIG. 2.

FIG. 8 is a flow chart showing an operation of registering a new content item by a static peer in the peer-to-peer-type content distribution system shown in FIG. 2.

FIG. 9 is a flow chart showing a content item distribution operation by a dynamic peer in the peer-to-peer-type content distribution system shown in FIG. 2.

FIG. 10 is a flow chart showing in detail a content item registration operation (local) shown in FIG. 8 or FIG. 9.

FIG. 11 is a flow chart showing in detail a content information registration operation (global) shown in FIG. 8 or FIG. 9.

FIG. 12 shows an example of a content item distribution operation by the peer-to-peer-type content distribution system shown in FIG. 2.

FIG. 13 shows a load calculation parameter table provided in a center server shown in FIG. 12.

FIG. 14 is a flow chart showing a content item distribution operation by the peer-to-peer-type content distribution system shown in FIG. 12.

### DETAILED DESCRIPTION OF THE PREFERRED EMBODIMENTS

A preferred embodiment of the present invention will now be described with reference to the drawings. Like elements are denoted by like reference numerals throughout the various figures, and will not be described repeatedly.

1. Configuration

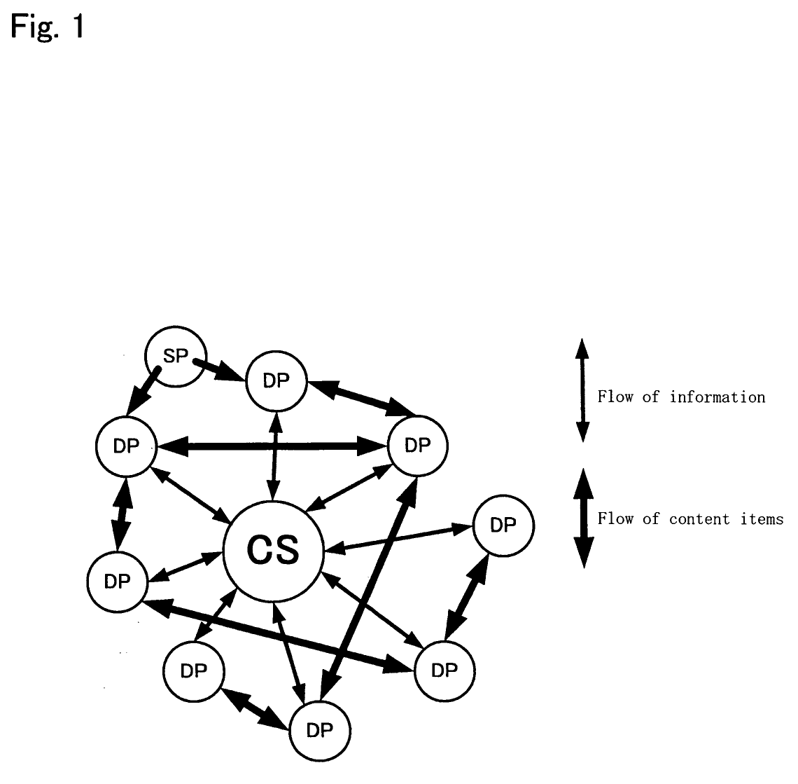

Referring to FIG. 1, a peer-to-peer-type content distribution system according to the embodiment of the present invention includes a center server CS and a number of dynamic peers DP. They are connected together via a telecommunications line (not shown) such as the Internet. Content items are distributed among the dynamic peers DP by being exchanged between the dynamic peers DP. Therefore, content items are stored in the dynamic peers DP and not in the center server CS.

The center server CS controls the distribution of content items among the dynamic peers DP by collecting information regarding the particulars and the locations of content items stored in the dynamic peers DP (hereinafter referred to as “content information”) and by sending the collected content information to the dynamic peers DP.

Each dynamic peer DP sends the center server CS the content information regarding content items stored therein, and receives from the center server CS the content information regarding a desired content item. Therefore, each dynamic peer DP functions also as a client with respect to the center server CS. Based on the content information obtained from the center server CS, each dynamic peer DP downloads a desired content item from another dynamic peer DP.

The system further includes one or more static peers SP similar in function to the dynamic peers DP. The static peer SP serves as the source of content distribution, and does not perform operations such as retrieving content information regarding a desired content item from the center server CS or downloading a desired content item from a dynamic peer DP. A dynamic peer DP can download a desired content item not only from other dynamic peers DP but also from the static peer SP.

For example, the center server CS may be commonly operated by a plurality of content vendors. Each static peer SP may be operated by a single content vendor. Each dynamic peer DP may be operated by a user who purchases content items. Specifically, each dynamic peer DP may be a user's personal computer, which has a 24-hour Internet connection via a high-speed broadband service such as FTTH (Fiber To The Home), ADSL (Asymmetric Digital Subscriber Line) and CATV (Cable TV).

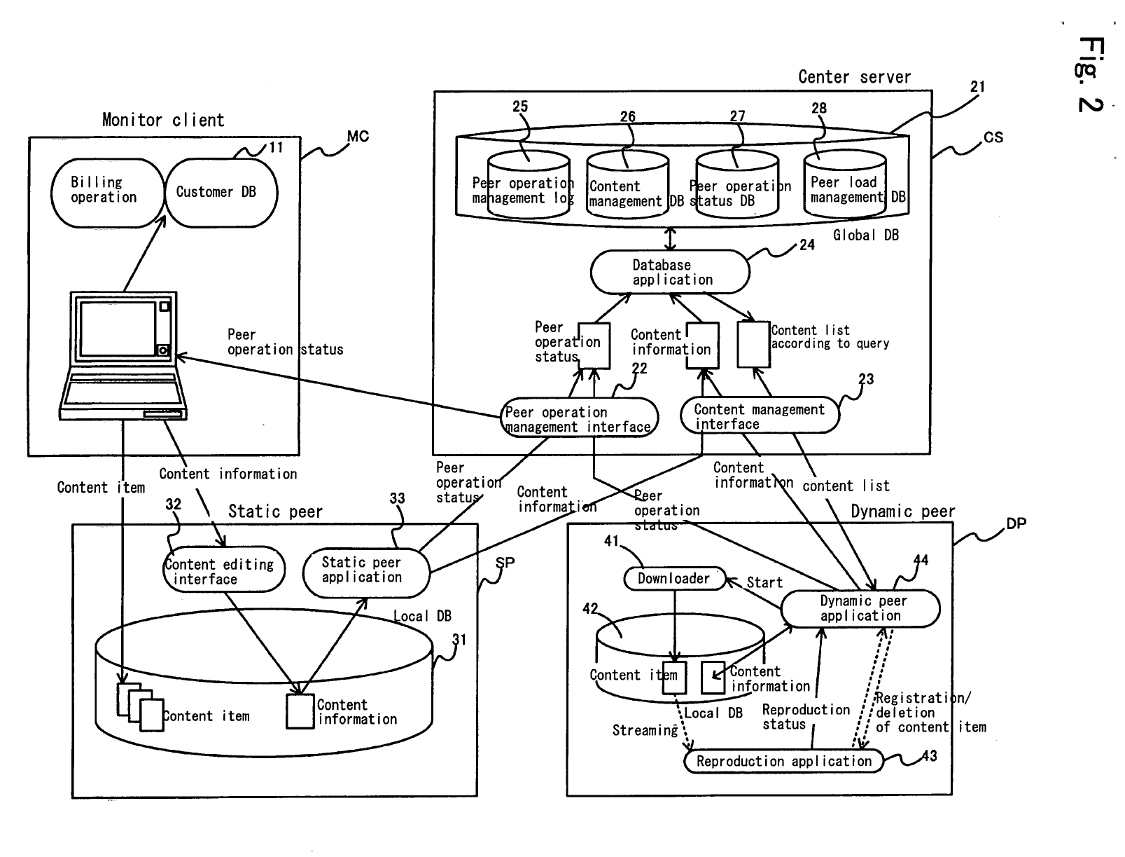

Referring now to FIG. 2, a specific configuration of the system will be described.

1.1 Monitor Client

In addition to the elements shown in FIG. 1, the system further includes one or more monitor clients MC for monitoring the system. For example, the monitor client MC is operated by a content vendor.

The monitor client MC has a function of registering new content items to be sent to the dynamic peers DP in the static peer SP, and a function of editing meta information of each new content item and sending it to the static peer SP. The monitor client MC also has a customer database 11, and performs a billing operation according to the content distribution status reported from the center server CS.

1.2. Center Server

The center server CS includes a global database 21, a peer operation management interface 22, a content management interface 23, and a database application 24.

The global database 21 includes a peer operation management log 25, a content management database 26, a peer operation status database 27, and a peer load management database 28. The peer operation management log 25 is used for recording the operations history of the peers SP and DP. The content management database 26 stores the content information for content items stored in the peers SP and DP. The peer operation status database 27 stores the operation status of the peers SP and DP. The peer load management database 28 stores load information regarding the load on the peers SP and DP.

The peer operation management interface 22 receives operation status information from each peer SP or DP (hereinafter referred to as the “peer operation status”), and sends the peer operation status to the monitor client MC.

The content management interface 23 receives content information from the peers SP and DP. The content management interface 23 also receives a query issued from a dynamic peer DP, and sends a content list produced according to the query to the dynamic peer DP.

The database application 24 registers the peer operation status received by the peer operation management interface 22 in the peer operation status database 27, and calculates the load on the peers SP and DP based on the peer operation status to register the load information regarding the calculated load in the peer load management database 28. The database application 24 registers the content information received by the content management interface 23 in the content management database 26. The database application 24 performs a search through the content management database 26 and the peer load management database 28 according to the query received by the content management interface 23, and produces a content list including the retrieved content information and load information.

1.3. Static Peer

The static peer SP includes a local database 31, a content editing interface 32, and a static peer application 33.

The local database 31 stores a number of new content items released from the monitor client MC. The content editing interface 32 registers, in the local database 31, the new content items uploaded from the monitor client MC and the content information for the new content items. The static peer application 33 sends the content information of the registered new content items to the center server CS as “new arrivals information”. The static peer application 33 also sends a requested content item to a dynamic peer DP in response to a request from the dynamic peer DP.

1.4. Dynamic Peer

The dynamic peer DP includes a downloader 41, a local database 42, a reproduction application 43, and a dynamic peer application 44.

The downloader 41 downloads desired content items from the static peer SP or other dynamic peers DP. The local database 42 stores the downloaded content items. The reproduction application 43 reads out a desired content item from the local database 42 by a streaming method, and reproduces sound and/or video images based on the content item.

The dynamic peer application 44 issues a query requesting the center server CS to send the content information for a desired content item and the load information, and registers the content information for the desired content item and the load information in the local database 42 based on the content list obtained from the center server CS. The dynamic peer application 44 specifies one or more peers storing the desired content item based on the obtained content information and load information, and further specifies one of those peers for which the load is lowest. The dynamic peer application 44 requests the desired content item from the specified peer, and starts the downloader 41 for downloading the desired content item. The dynamic peer application 44 registers the downloaded content item in the local database 42. The dynamic peer application 44 sends the content information for the registered content item and the operation status of itself to the center server CS. The dynamic peer application 44 can also send a desired content item in response to a request from another dynamic peer DP. The dynamic peer application 44 can also delete a desired content item from the local database 42 in response to a user's operation.

1.5. Records in Content Management Database

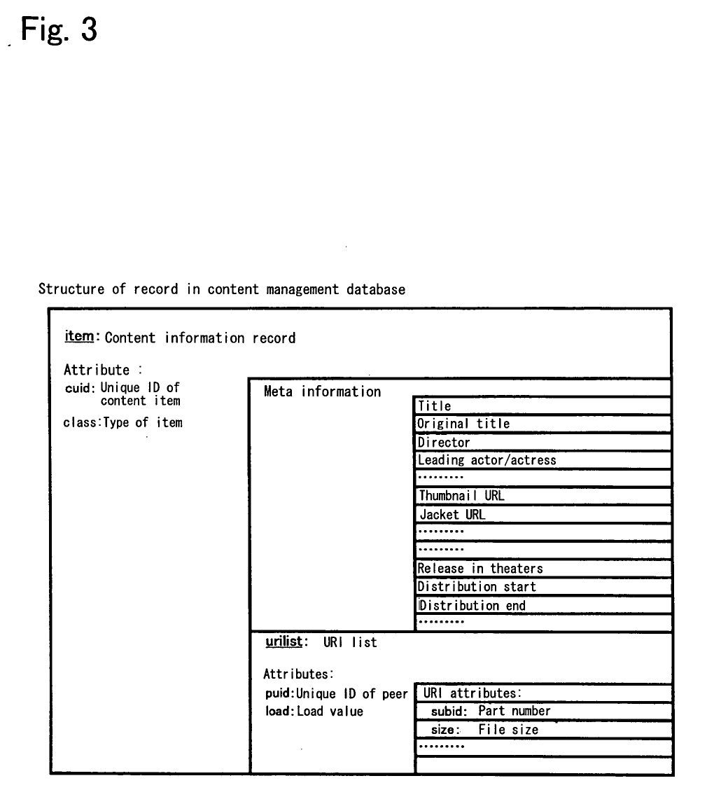

FIG. 3 shows the data structure of a record in the content management database 26. The content management database 26 includes a number of content information records (‘item’), and the number of content information records is equal to the total number of content items. Each content information record (‘item’) includes meta information and one or more URI lists (‘urilist’). The attributes of the content information record (‘item’) include the unique ID (‘cuid’) of the content item and the type (‘class’) of the content item (“video”, “music”, etc.).

The meta information represents the particulars of the content item, including the title of the content item, the name of the director, and the name of the leading actor/actress. The URI list (‘urilist’) is location information representing the location of the content item. The number of URI lists (‘urilist’) included in a content information record (‘item’) is equal to the number of the peers SP and DP having the content item stored therein. The attributes of the URI list (‘urilist’) include the unique ID (‘puid’) of the peer SP or DP having the content item stored therein, and the load value (‘load’) of the peer SP or DP.

A content item stored in a peer SP or DP is divided into one or more files. The URI list (‘urilist’) includes one or more URIs (Uniform Resource Identifiers) indicating the locations of these files. The attributes of the URI include the part number (‘subid’) and the file size (‘size’) of each file.

1.6. Content Management Database

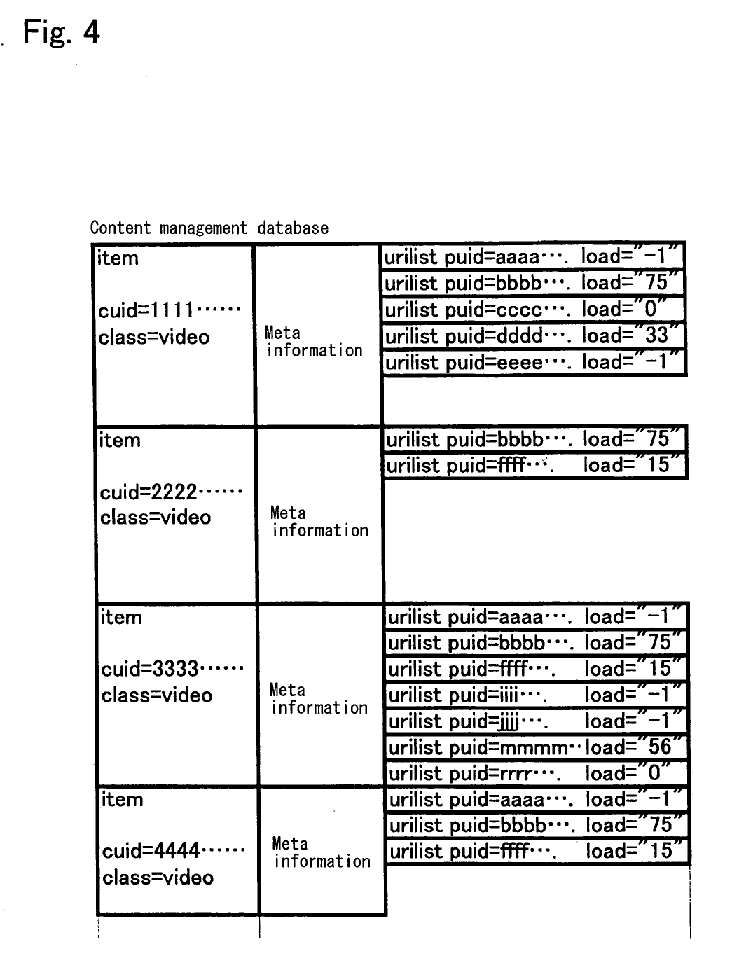

FIG. 4 shows an example of the content management database 26. The content management database 26 has meta information and one or more URI lists (‘urilist’) for each content information record (‘item’). In the example shown in FIG. 4, a content item whose unique content ID is “1111 . . . ” is stored in peers SP or DP whose unique peer IDs are “aaaa . . . ”, “bbbb . . . ”, “cccc . . . ”, “dddd . . . ” and “eeee . . . ”. For example, the peer SP or DP whose unique peer ID is “bbbb . . . ” has a load value (‘load’) of “75”.

1.7. Local Database

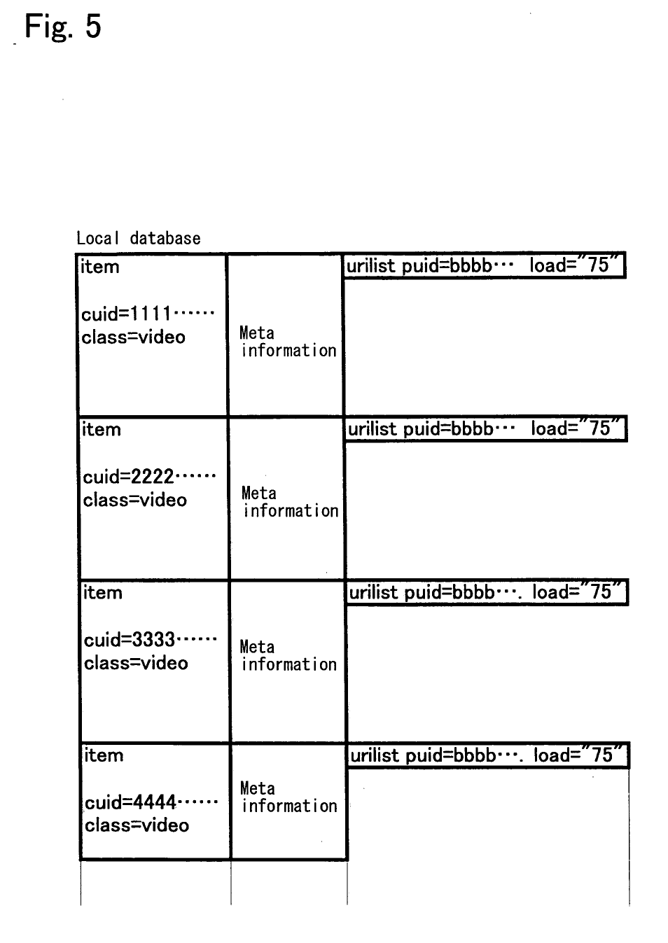

FIG. 5 shows an example of the local database 31 or 42. The local database 31 or 42 has the meta information and the URI list (‘urilist’) for each content information record (‘item’). The example shown in FIG. 5 is the local database 31 or 42 for the peer SP or DP whose unique peer ID is “bbbb . . . ”.

1.8. Peer Operation Status Database

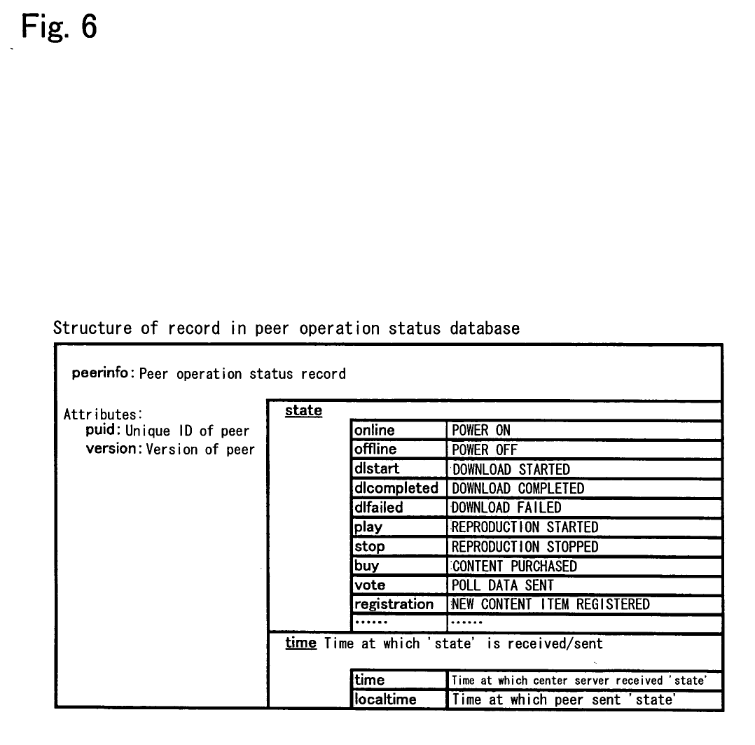

FIG. 6 shows the data structure of a record in the peer operation status database 27. The peer operation status database 27 includes a number of peer operation status records (‘peerinfo’), and the number of peer operation status records is equal to the total number of the static peer SP and the dynamic peers DP. Each peer operation status record (‘peerinfo’) includes the peer operation status (‘state’) representing the operation status of the peer, and the time of sending/receiving (‘time’) of the peer operation status (‘state’). The attributes of the peer operation status record (‘peerinfo’) include the unique ID (‘puid’) of the peer and the version (‘version’) of the peer. The peer operation status (‘state’) includes various indicators such as POWER ON (‘online’), POWER OFF (‘offline’), DOWNLOAD STARTED (‘dlstart’), DOWNLOAD COMPLETED (‘dlcompleted’), REPRODUCTION STARTED (‘play’), REPRODUCTION STOPPED (‘stop’), and NEW CONTENT ITEM REGISTERED (‘registration’). Operation status indicators such as POWER ON (‘online’) and POWER OFF (‘offline’) are commonly used with static and dynamic peers SP and DP. Operation status indicators such as DOWNLOAD STARTED (‘dlstart’), DOWNLOAD COMPLETED (‘dlcompleted’), REPRODUCTION STARTED (‘play’) and REPRODUCTION STOPPED (‘stop’) are unique to dynamic peers DP. The operation status indicator NEW CONTENT ITEM REGISTERED (‘registration’) is unique to static peers SP.

1.9. Peer Load Management Database

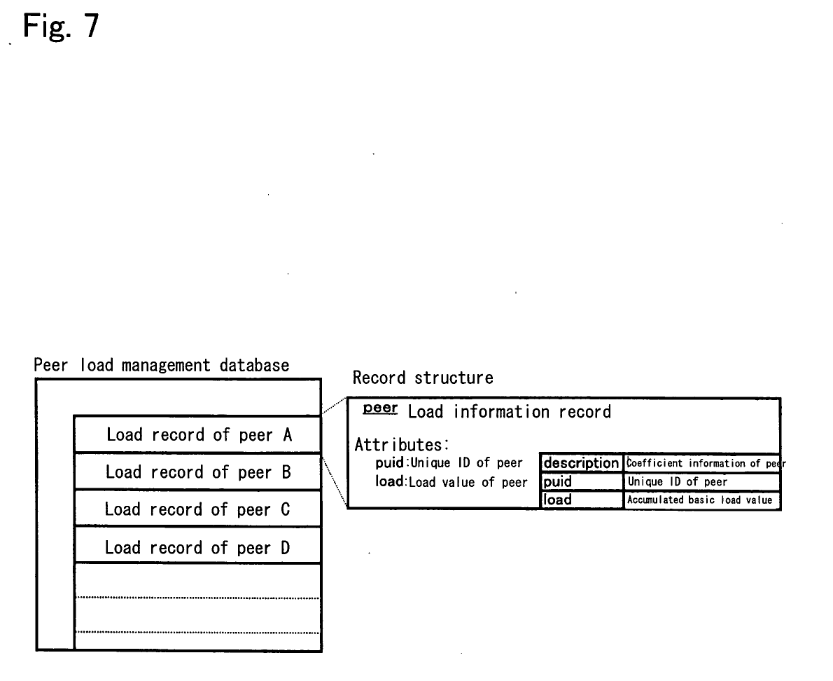

FIG. 7 shows the data structure of a record in the peer load management database 28. The peer load management database 28 includes a number of load information records (‘peer’), and the number of load information records is equal to the total number of the static and dynamic peers SP and DP. Each load information record (‘peer’) for a peer includes the load information of the peer. Specifically, the load information of a peer includes coefficient information (‘description’) of the peer, e.g., the specifications coefficient or the type of the peer (indicating whether the peer is a download-only peer or a peer capable of uploading files), the unique ID (‘puid’) of the peer, and the accumulated basic load value (load value) (‘load’). The attributes of the load information record (‘peer’) include the unique ID (‘puid’) of the peer and the load value (‘load’) of the peer.

While an original copy of the unique ID (‘puid’) and the load value (‘load’) is stored in the peer load management database 28, a duplicate copy of the data is also stored in the content management database 26 as the URI list (‘urilist’), as mentioned above.

2. Operation

An operation of the system will now be described.

2.1. Registration of New Content Item

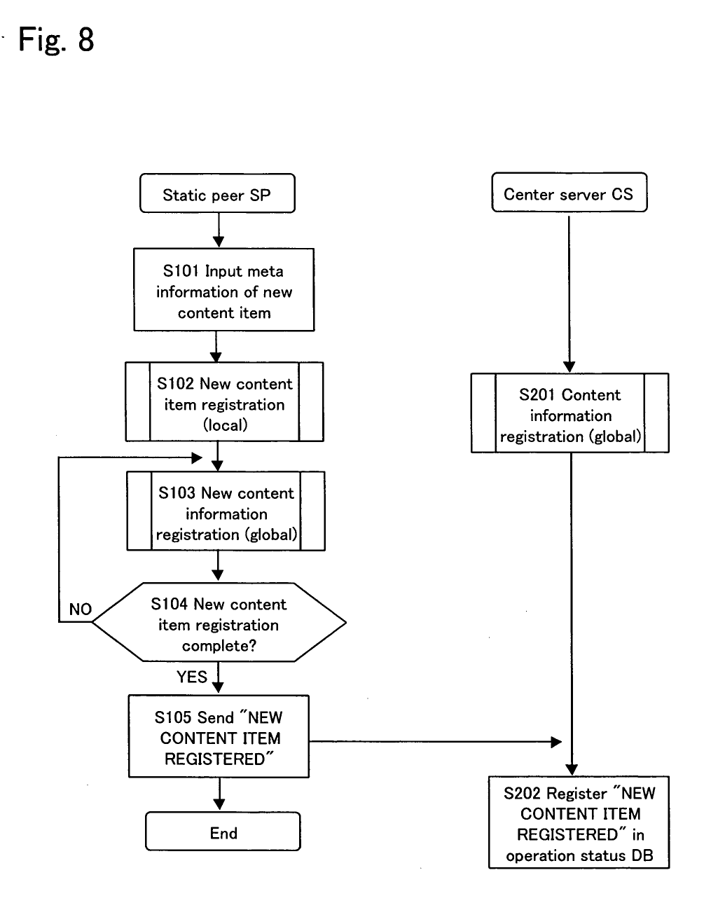

First, an operation of registering a new content item will be described with reference to FIG. 8.

In the static peer SP, the content editing application 32 inputs meta information of the new content item in various fields of the content information record (‘item’) shown in FIG. 3 (S101). Meta information sent from the monitor client MC may be input, or meta information imported from an existing database (not shown) may be input. Alternatively, meta information may be manually input.

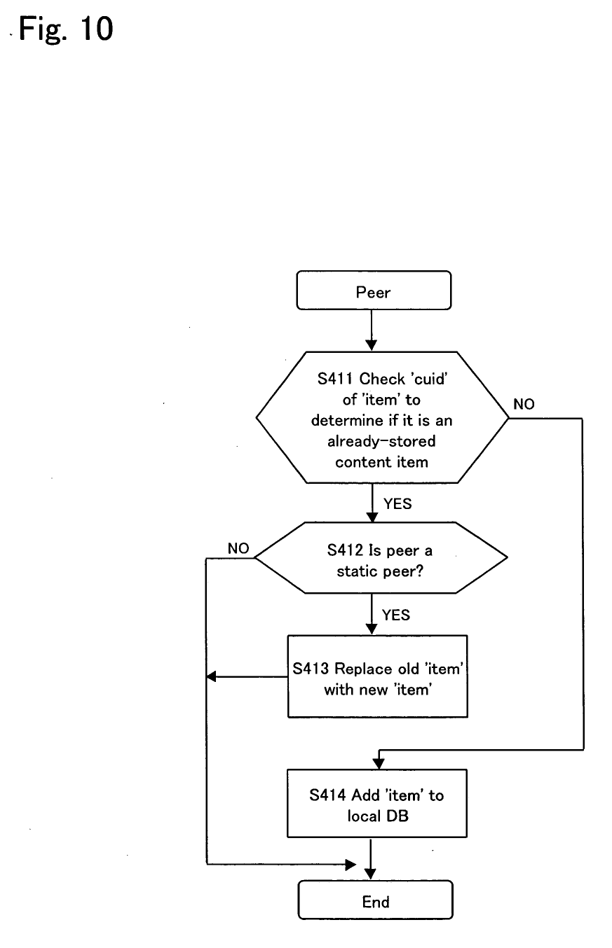

Then, the content editing application 32 registers the new content item uploaded from the monitor client MC and the content information thereof in the local database 31 (S102). The details of this operation will be described later (FIG. 10).

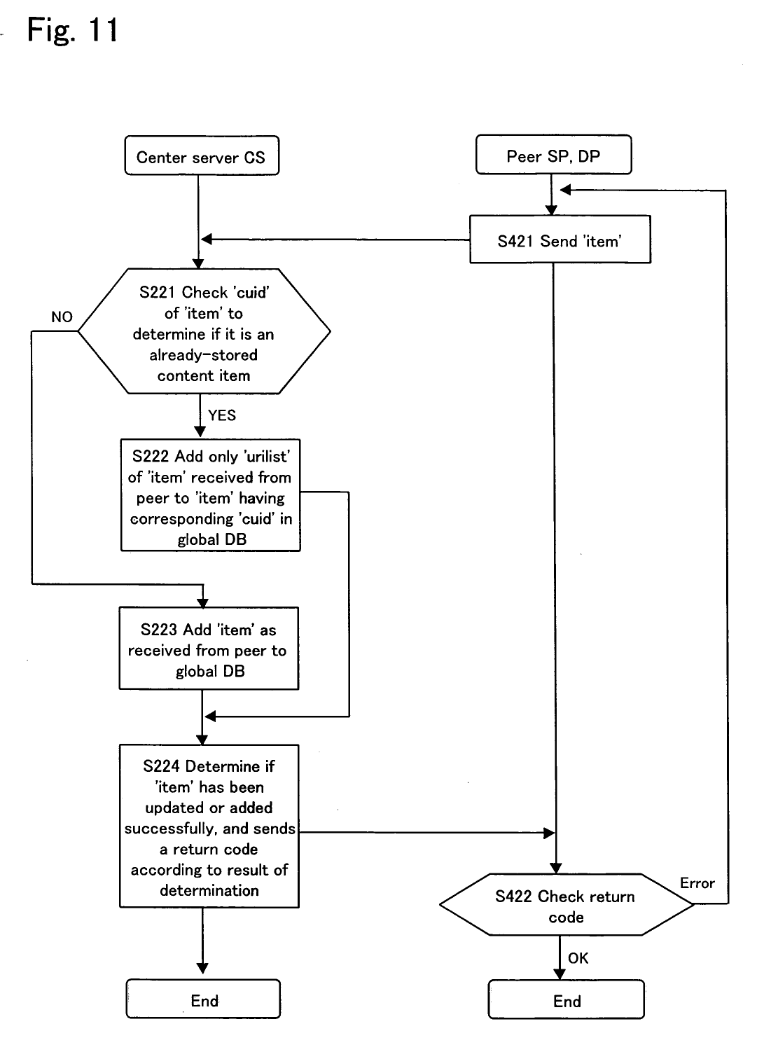

Then, the static peer application 33 sends the registered content information to the center server CS (S103). In the center server CS, the database application 24 registers the content information sent from the static peer SP in the content management database 26 in the global database 21 (S201). The details of this operation will be described later (FIG. 11).

When the registration of the new content item is completed (S104), the static peer application 33 sends the operation status NEW CONTENT ITEM REGISTERED (‘registration’) to the center server CS (S105). In the center server CS, the database application 24 registers the operation status NEW CONTENT ITEM REGISTERED (‘registration’) in the peer operation status database 27 (S202).

2.2. Downloading Content Item

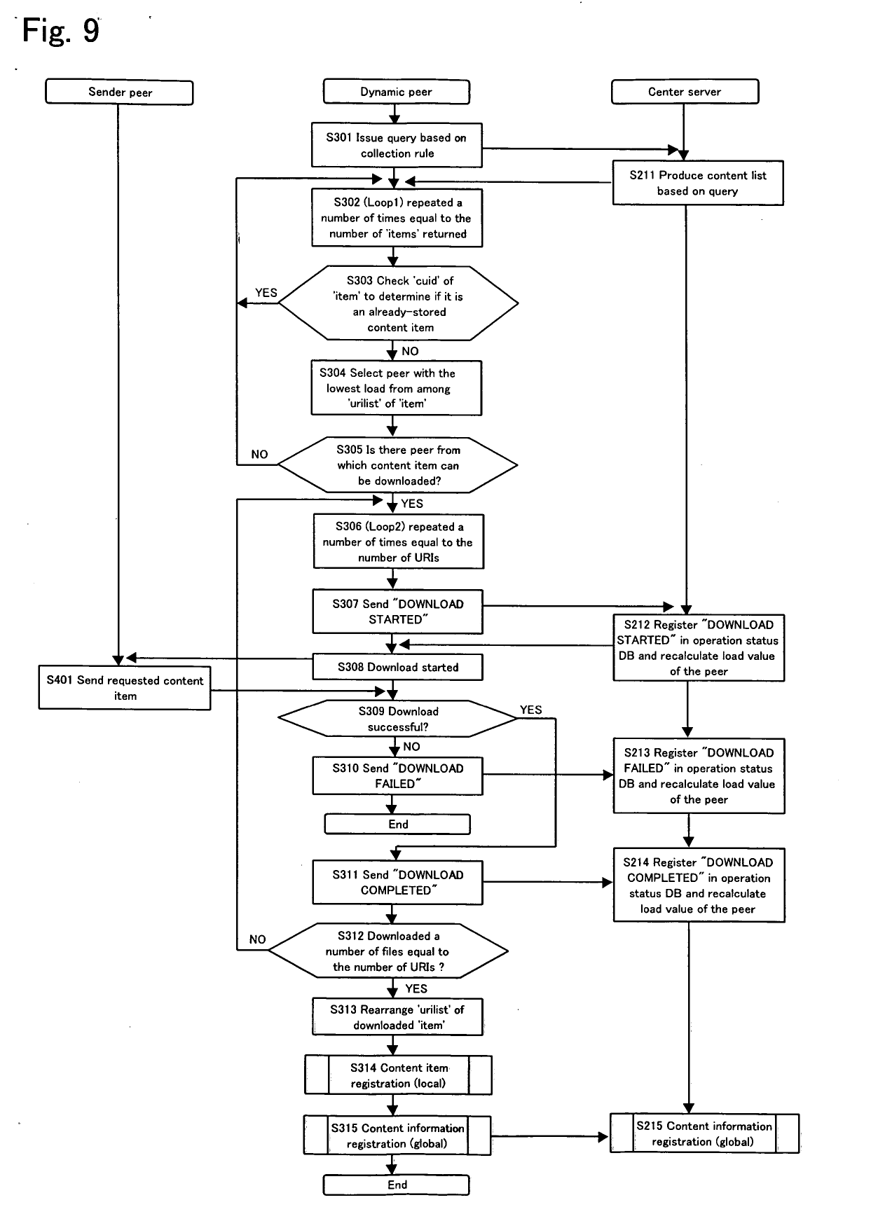

Referring now to FIG. 9, an operation of downloading a content item will be described.

In a dynamic peer DP, the dynamic peer application 44 issues a query to the center server CS based on a predetermined collection rule (S301). In response to this, the database application 24 of the center server CS produces a content list based on the query and sends the produced content list to the dynamic peer DP which issued the query (S211).

The collection rule for each dynamic peer DP is created in advance through the operation by the user of the dynamic peer DP. For example, a collection rule may be created based on the name of the director or the name of the leading actor/actress according to the user's preference. Then, the database application 24 performs a search through the content management database 26 by the name of the director or the name of the leading actor/actress to retrieve one or more content information records (‘item’), and produces a content list including the content information records (‘item’).

The dynamic peer application 44 repeats the following steps (steps S303 to S305) a number of times equal to the number of content information records (‘item’) included in the received content list (S302).

First, the dynamic peer application 44 compares the unique ID (‘cuid’) of each content item included in the content information record (‘item’) with the unique ID (‘cuid’) of each content item registered in the local database 42 of the dynamic peer DP to determine whether or not the dynamic peer DP already has the listed content item stored therein (S303). If the dynamic peer DP already has the listed content item stored therein (YES in S303), the dynamic peer application 44 returns to step S302 to check the next content information record (‘item’).

If the dynamic peer DP does not have the listed content item stored therein (NO in S303), the dynamic peer application 44 selects a URI list (‘urilist’) that has the smallest load value (‘load’) (excluding negative load values) from among one or more URI lists (‘urilist’) included in the content information record (‘item’), thus selecting a peer SP or DP with the lowest load (S304).

If there is no peer from which the content item can be downloaded (NO in S305), the dynamic peer application 44 returns to step S302 to check the next content information record (‘item’).

If there is a peer from which the content item can be downloaded (YES in S305), the dynamic peer application 44 repeats the following steps (steps S307 to S312) a number of times equal to the number of URIs included in the selected URI list (‘urilist’) (S306).

First, the dynamic peer application 44 sends the operation status DOWNLOAD STARTED (‘dlstart’) to the center server CS (S307). In response to this, the database application 24 of the center server CS registers the operation status DOWNLOAD STARTED (‘dlstart’) in the peer operation status database 27, and recalculates the load value of the dynamic peer DP to update the load value (‘load’) in the content management database 26 and the peer load management database 28 (S212).

Then, the dynamic peer application 44 requests the peer SP or DP with the lowest load to send the content item and downloads the content item (S308). In response to this, the static peer application 33 or the dynamic peer application 44 of the requested peer SP or DP sends (uploads) the requested content item to the requesting dynamic peer DP (S401).

If the download fails (NO in S309), the dynamic peer application 44 sends the operation status DOWNLOAD FAILED (‘dlfailed’) to the center server CS (S310). In response to this, the database application 24 of the center server CS registers the operation status DOWNLOAD FAILED (‘dlfailed’) in the peer operation status database 27, and recalculates the load value of the dynamic peer DP to update the load value (‘load’) in the content management database 26 and the peer load management database 28 (S213).

If the download is successful (YES in S309), the dynamic peer application 44 sends the operation status DOWNLOAD COMPLETED (‘dlcompleted’) to the center server CS (S311). In response to this, the database application 24 of the center server CS registers the operation status DOWNLOAD COMPLETED (‘dlcompleted’) in the peer operation status database 27, and recalculates the load value of the dynamic peer DP to update the load value (‘load’) in the content management database 26 and the peer load management database 28 (S214).

These steps (steps S307 to S310) are repeated until one or more files, into which the content item has been divided, are all downloaded (S312).

Then, the dynamic peer application 44 rearranges the URI list (‘urilist’) of the downloaded content item (S313). Specifically, the dynamic peer application 44 deletes the URIs of the other peers from the URI list of the content item so that there is only the URI of the dynamic peer DP in the URI list. Thus, the data size of the content information can be reduced, and the URI of the peer having newly downloaded a content item can be registered in the content management database 26.

Then, the dynamic peer application 44 registers the downloaded content item and the content information thereof in the local database 42 (S314). The details of this operation will be described later (FIG. 10).

Then, the dynamic peer application 44 sends the registered content information to the center server CS (S315). In response to this, the database application 24 of the center server CS registers the content information sent from the dynamic peer DP in the content management database 26 in the global database 21 (S215). The details of this operation will be described later (FIG. 11).

2.3. Content Item Registration (Local)

Referring now to FIG. 10, the content item registration steps S102 and S314 will be described in greater detail.

The static peer application 33 or the dynamic peer application 44 of a peer SP or DP compares the unique ID (‘cuid’) of each content item included in the content information record (‘item’) with the unique ID (‘cuid’) of each content item registered in the local database 42 of the peer SP or DP to determine whether or not the peer SP or DP already has the content item stored therein (S411). If the peer SP or DP already has the content item stored therein (YES in S411) and if the peer is a static peer SP (YES in S412; the new content item registration shown in FIG. 8), the old content information record (‘item’) is replaced with the new content information record (‘item’), thus updating the content information. If the peer already has the content item stored therein, it is usually unnecessary to update the content information. Nevertheless, in a case where an already-registered piece of meta information (e.g., the name of the director) is erroneous, the erroneously-registered piece of meta information can be corrected by updating the content information.

If the peer SP or DP does not have the content item stored therein (NO in S411), the peer application 33 or 44 adds the content information record (‘item’) to the local database 31 or 42 (S414).

2.4. Content Information Registration (Global)

Referring now to FIG. 11, the content information registration steps S103 and S315 will be described in greater detail.

The peer application 33 or 44 sends the content information record (‘item’) to the center server CS (S421). In response to this, the database application 24 of the center server CS compares the unique ID (‘cuid’) of each content item included in the content information record (‘item’) with the unique ID (‘cuid’) of each content item registered in the content management database 26 to determine whether or not the peer SP or DP already has the content item stored therein (S221).

If the peer SP or DP already has the content item stored therein (YES in S221), the database application 24 performs a search through the content management database 26 by the unique ID (‘cuid’) of the content item, and adds only the URI list (‘urilist’) of the content information record (‘item’) sent from the peer SP or DP to the content information record (‘item’) having the unique ID (‘cuid’), thus updating the content information record (‘item’) (S222).

If the peer SP or DP does not have the content item stored therein (NO in S221), the database application 24 adds the content information record (‘item’) as received from the peer SP or DP to the content management database 26 (S223).

After the content information record (‘item’) is updated or added, the database application 24 determines whether or not the content information record (‘item’) has been updated or added successfully, and sends a predetermined return code to the peer SP or DP according to the result of the determination (S224). In response to this, the peer application 33 or 44 of the peer SP or DP checks the return code sent from the center server CS (S422). If it is determined that the updating or addition of the content information record (‘item’) has failed, the application retries to send the content information record (‘item’) (S421).

2.5. Example of how Content Item is Downloaded

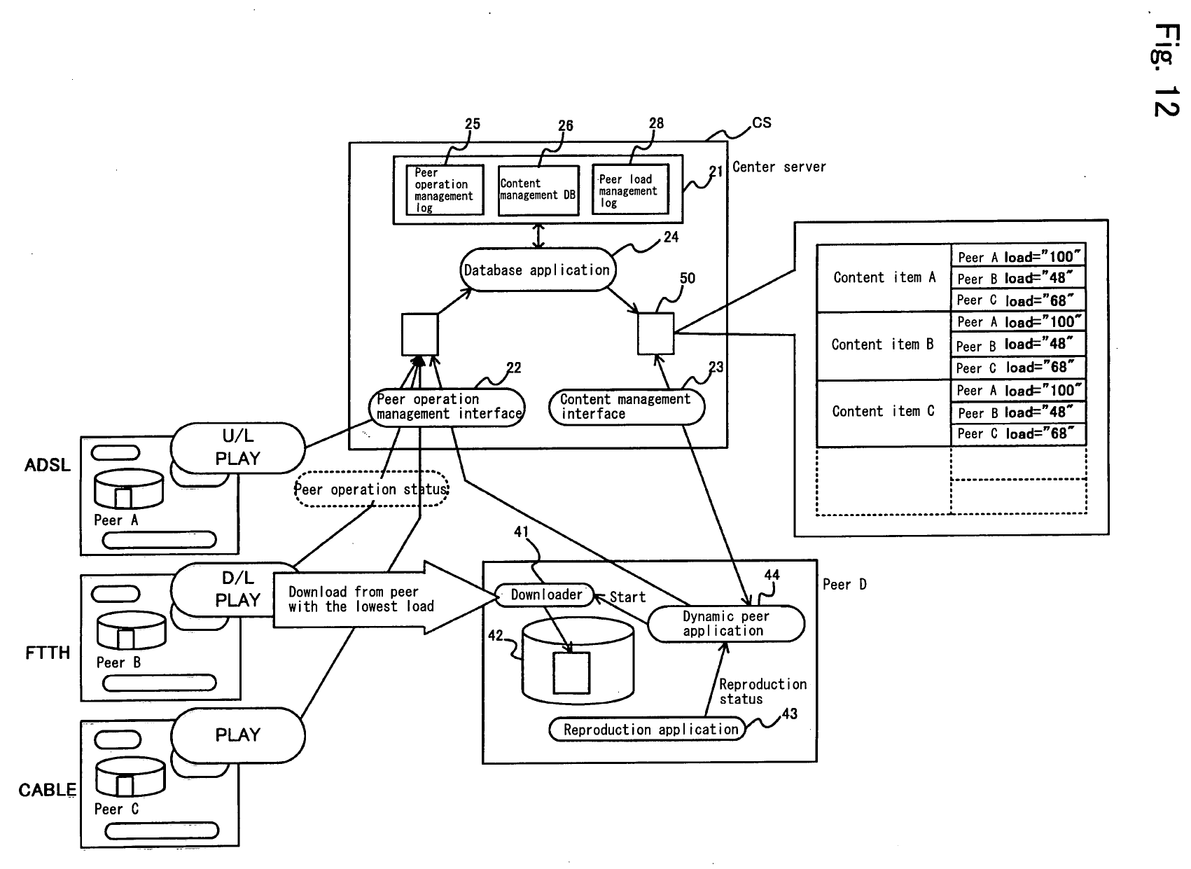

Assume that there are four peers A, B, C and D (each being either a static or dynamic peer SP or DP), as shown in FIG. 12, and the peer D (a dynamic peer DP) is about to download a content item C from one of the peers A, B and C. It is also assumed that the peer A is connected to the Internet via ADSL and is uploading a file while reproducing a file, the peer B is connected to the Internet via FTTH and is downloading a file while reproducing a file, and the peer C is connected to the Internet via CATV and is reproducing a file.

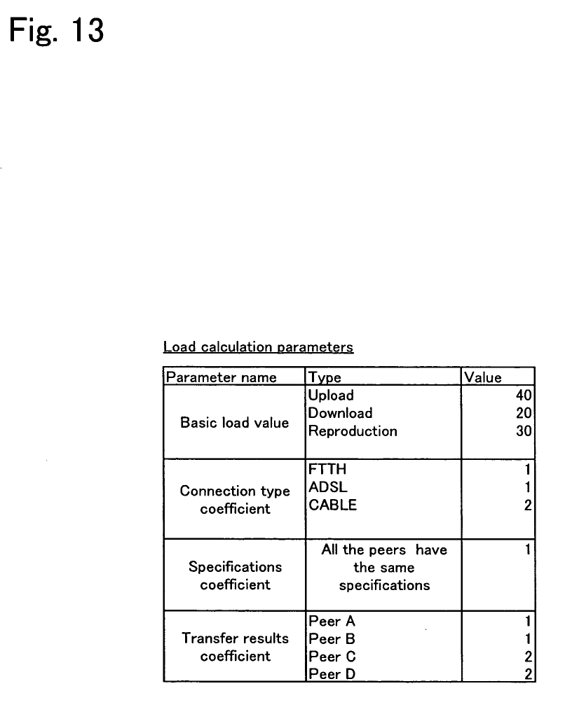

The center server CS has a load calculation parameter table as shown in FIG. 13. In this table, various parameters needed for calculating the load values (‘load’) of the peers SP and DP are registered in advance. The load value (‘load’) is calculated based on Expression 1 below.
Load value=Basic load value×Connection type coefficient33 Specifications coefficient×Transfer results coefficient Expression 1

In the example shown in FIG. 12, the load value (‘load’) of the peer A is 118 (≈(40+30)×1.2×1.0×1.4), the load value (‘load’) of the peer B is 48 (≈(20+30)×0.8×1.0×1.2), and the load value (‘load’) of the peer C is 68 (≈30×1.5×1.0×1.5).

The basic load value of a peer is a numerical value determined according to the operation status of the peer (e.g., uploading a file, downloading a file or reproducing a file). The center server CS registers the basic load value of a peer in the peer load management database 28 based on the peer operation status sent from the peer.

Specifically, in response to the operation status DOWNLOAD STARTED (‘dlstart’), the database application 24 increases the basic load value of the file source peer (a peer that is to upload a content item) by 40, and increases the basic load value of the reporting peer (i.e., a peer that has reported its operation status to the center server CS) (a peer that is to download the content item) by 20. In response to the operation status DOWNLOAD COMPLETED (‘dlcompleted’), the database application 24 decreases the basic load value of the file source peer (a peer that has uploaded the content item) by 40, and decreases the basic load value of the reporting peer (a peer that has downloaded the content item) by 20. In response to the operation status DOWNLOAD FAILED (‘dlfailed’), the database application 24 decreases the basic load value of the reporting peer (a peer that has failed to download the content item) by 20, and sets the basic load value of the file source peer to −1. This indicates that the file source peer is off-line and cannot be accessed.

In response to the operation status REPRODUCTION STARTED (‘play’), the database application 24 increases the basic load value of the reporting peer (a peer that has started reproducing a file) by 30. In response to the operation status REPRODUCTION STOPPED (‘stop’), the database application 24 decreases the basic load value of the reporting peer (a peer that has stopped reproducing a file) by 30.

While only three types of events are listed in the table shown in FIG. 13, the table may further include other types of events, such as fast forwarding and pausing, together with the associated basic load values.

The connection type coefficient is a weighting coefficient (factor) determined in advance for each peer according to the connection type of the peer. The connection type coefficient is used because the data transfer rate varies depending on the connection type (e.g., FTTH, ADSL or CABLE).

The specifications coefficient is a weighting coefficient (factor) determined in advance for each peer according to the hardware specifications of the peer (the processing power of the CPU, the disk I/O capacity, etc.). In the illustrated example, it is assumed that the peers all have the same level of hardware specifications, and therefore the specifications coefficient is set to 1 for all the peers. The difference between a dedicated file transfer peer provided at an iDC, or the like, and an ordinary peer provided in a user's house may also be reflected in the specifications coefficient.

The transfer results coefficient is a coefficient determined based on the actual results of file transfers in the past. It is preferred that the coefficient is dynamically updated based on the actual results. Alternatively, the coefficient may be manually changed so as to increase/decrease the load on a particular peer.

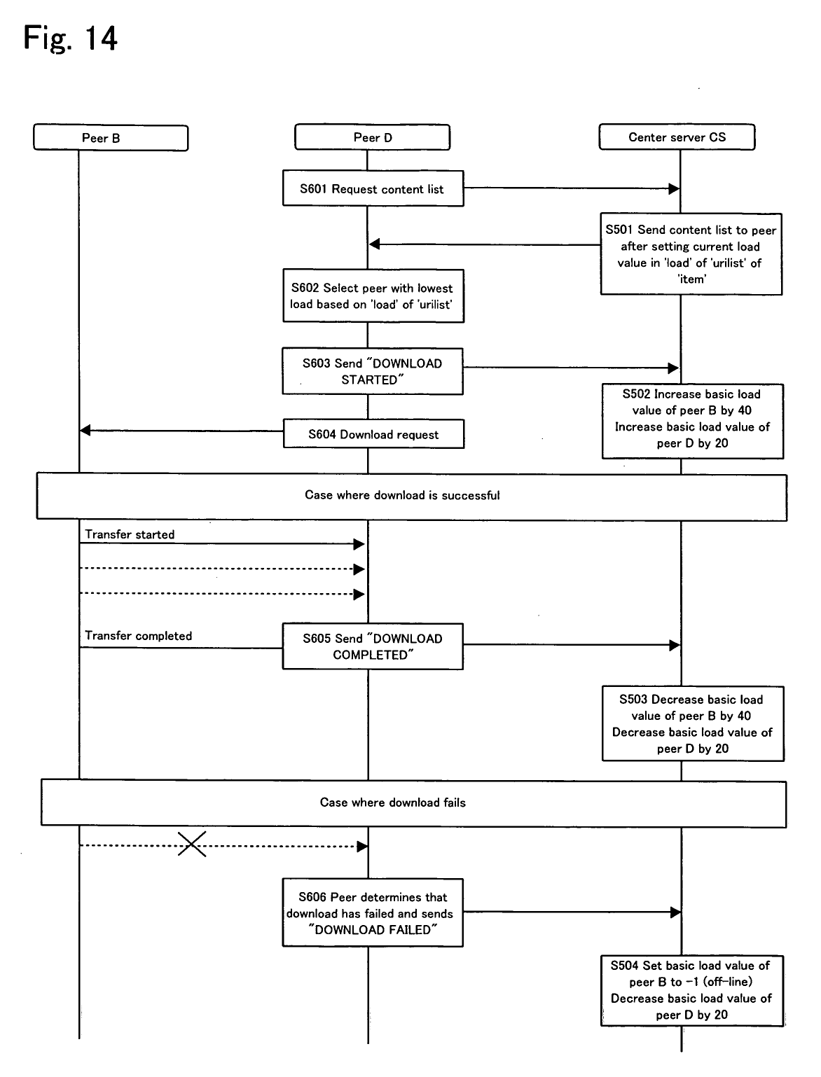

An operation in which the peer D downloads the content item C under the following conditions will be described with reference to FIG. 14.

The peer D issues a query to request the center server CS to send a content list 50 (S601). In response to the request, the center server CS sends the content list 50 to the peer D after setting the load value (‘load’) currently registered in the URI list attribute (‘urilist’) of the content information record (‘item’) (S501).

The peer D selects the peer B with the lowest load from among the load values (‘load’) of the URI list (‘urilist’) (S602). The peer D sends the operation status DOWNLOAD STARTED to the center server CS (S603), and requests the content item C from the peer B (S604).

The center server CS refers to the load calculation parameter table shown in FIG. 13 to increase the basic load value of the peer B which is to upload the content item C by 40 and increase the basic load value of the peer D which is to download the content item C by 20 (S502).

A case where the download is successful will now be described. The peer B starts sending the content item C. In other words, the peer D starts downloading the content item C from the peer B. When the download of the content item C is complete, the peer D sends the operation status DOWNLOAD COMPLETED to the center server CS (S605).

When the center server CS receives the operation status DOWNLOAD COMPLETED, the center server CS decreases the basic load value of the peer B, which has finished uploading the content item C, by 40 and decreases the basic load value of the peer D, which has finished downloading the content item C, by 20 (S503).

A case where the download fails will now be described. The peer D determines that the download has failed based on the occurrence of a connection failure or a connection timeout, in which case the peer D sends the operation status DOWNLOAD FAILED to the center server CS (S606).

When the center server CS receives the operation status DOWNLOAD FAILED, the center server CS sets the basic load value of the peer B, from which content items cannot be downloaded, to −1 (“off-line”) and decreases the basic load value of the peer D, which has failed to download the content item C, by 20 (S504).

As described above, according to the embodiment of the present invention, the center server CS collects content information records (‘item’) from the peers SP and DP. The collected content information records (‘item’) can be sent to a dynamic peer DP in response to a query issued from the dynamic peer DP. Thus, a dynamic peer DP can obtain the URI of another peer SP or DP that has a desired content item stored therein, and can download the desired content item from the peer SP or DP. Since the load value of each peer SP or DP is set in the URI list attribute (‘urilist’) included in the content information record (‘item’), a dynamic peer DP can select another peer SP or DP with the lowest load and download the desired content item from the selected peer SP or DP. Therefore, download requests are prevented from being concentrated at a particular peer SP or DP, and the content file transfer loads can be distributed among a number of peers. Since the operation status of each dynamic peer DP is reported to the center server CS, content items can be distributed while protecting the copyrights thereof.

While the unique IDs (‘puid’) of the peers SP and DP and the load values (‘load’) of the peers SP and DP are stored also in the content management database 26 in the embodiment described above, it is not necessary that they are stored therein as long as they are stored in the peer load management database 28.

In the embodiment described above, one peer with the lowest load is selected and a content item is downloaded from the selected peer. Alternatively, one peer may be selected simply based on the operation status of the peer (e.g., a peer that is not being uploading a file), and a content item may be downloaded from the selected peer. In a case where one peer is selected based on the operation status thereof, a peer with a smallest basic load value relating to the operation status (e.g., uploading, downloading, reproducing, standby) may be selected based only on the basic load value relating to the operation status among other parameters shown in FIG. 13, i.e., without taking into consideration the connection type coefficient, the specifications coefficient and the transfer results coefficient.

While the selection of a peer with the lowest load is made by a dynamic peer DP (S304), the selection can alternatively be made by the center server CS. In such a case, the content list sent from the center server CS to the dynamic peer DP only needs to include the URI of the peer with the lowest load. Specifically, in step S211 described above, the center server CS selects a peer with the lowest load based on the content management database 26 and the peer load management database 28, and produces a content list including the URI of the peer. In such a case, the dynamic peer DP selects a peer, which has been selected by the center server CS. In other words, a peer, which is selected by the center server CS based on the load information, is selected again by the dynamic peer DP. Where there are two peers with the lowest load, for example, it may be the case that the center server CS selects the two peers, and then the dynamic peer DP selects one of the two peers.

Alternatively, the center server CS may send the dynamic peer DP a content list in which content information records (‘item’) including URIs of peers are rearranged in the order of load, instead of the center server CS selecting one peer with the lowest load. In such a case, the dynamic peer DP can automatically select the peer with the lowest load by selecting the first peer in the content list. Alternatively, the center server CS may rearrange the content information records (‘item’) in the order of load, and select ten content information records (‘item’) therefrom with lowest load values. Then, even if there are many peers having a requested content item stored therein, it is possible to prevent the data size of the content list from being so large that it may congest the communications line.

While a content item is sent from a dynamic peer or a static peer to a requesting dynamic peer in response to a request from the requesting dynamic peer in the embodiment described above, a content item may be sent automatically from the sender peer (dynamic or static) to the requesting dynamic peer in response to an instruction from the center server, etc. The content information and the load information may also be sent automatically from the center server to the dynamic peer.

While the present invention has been described above in a preferred embodiment, it is understood that the embodiment is merely illustrative of how the invention may be carried out, and it is apparent to those skilled in the art that variations and modifications thereof can be made without departing from the spirit and scope of the invention.

The peer-to-peer-type content distribution system of the present invention is applicable to content distribution services using the Internet.

What is claimed is:

1. A peer-to-peer-type content distribution system, comprising a center server and a plurality of dynamic peers connected to the center server, the center server including:
a global storage section for storing content information regarding particulars and a location of each content item stored in each dynamic peer and load information regarding a load on the dynamic peer;
a content information registration section for registering the content information received from the dynamic peer in the global storage section;
a load information registration section for registering, in the global storage section, the load information of the dynamic peer according to an operation status received from the dynamic peer; and
an information returning section for returning, in response to a request from a dynamic peer, the content information and the load information to the dynamic peer, each dynamic peer including:
a local storage section for storing a plurality of content items;
a section for obtaining the content information and the load information from the center server;
a section for selecting one or more sender peers, being one or more of the plurality of dynamic peers, having a desired content item stored therein based on the obtained content information, and for further selecting one sender peer, from among the selected one or more sender peers, based on the obtained load information;
a section for downloading the desired content item from the selected sender peer;
a section for registering the downloaded content item in the local storage section;
a section for sending content information of the registered content item to the center server;
an operation status notification section for sending an operation status of the dynamic peer to the center server; and
a section for uploading a desired content item to other peers.

2. The peer-to-peer-type content distribution system according to claim 1, wherein:
the content information of a content item includes meta information regarding particulars of the content item and location information regarding a location of the content item;
the location information includes identification information regarding an identification of each peer having the content item stored therein and load information regarding a load on the peer.

3. The peer-to-peer-type content distribution system according to claim 1, wherein:
the load information registration section calculates the load information of a dynamic peer based on the operation status of the dynamic peer, and registers the calculated load information in the global storage section.

4. The peer-to-peer-type content distribution system according to claim 1, wherein in response to a request from a dynamic peer, the information returning section performs a search through the global storage section to retrieve content information and load information, so as to produce a content list including the retrieved content information and load information and send the produced content list to the dynamic peer.

5. The peer-to-peer-type content distribution system according to claim 1, further comprising a static peer connected to the center server, the static peer including:
a local storage section for storing a plurality of content items;
a section for registering a content item in the local storage section;
a section for sending content information of the registered content item to the center server;
an operation status notification section for sending an operation status of the static peer to the center server; and
a section for uploading a desired content item to a requesting dynamic peer, wherein:
the content information registration section registers the content information sent from the static peer in the global storage section; and
the load information registration section registers load information in the global storage section according to the operation status sent from the static peer.

6. A dynamic peer connectable to a center server being connected to one or more dynamic peers, comprising:
a local storage section for storing a plurality of content items;
a section for requesting and obtaining, from the center server, content information regarding particulars and a location of each content item stored in each dynamic peer and load information regarding a load on the dynamic peer;
a section for selecting one or more sender peers, being one or more of the one or more dynamic peers, having a desired content item stored therein based on the obtained content information, and for further selecting one sender peer, from among the selected one or more sender peers, based on the obtained load information;
a section for downloading the desired content item from the selected sender peer;
a section for registering the downloaded content item in the local storage section;
a section for sending content information of the registered content item to the center server;
a section for sending an operation status of the dynamic peer to the center server; and
a section for uploading a desired content item to other dynamic peers.

7. The dynamic peer according to claim 6, wherein:
the content information of a content item includes meta information regarding particulars of the content item and location information regarding a location of the content item;
the location information includes identification information regarding an identification of each peer having the content item stored therein and load information regarding a load on the peer.

8. A center server connectable to a plurality of dynamic peers, comprising:
a global storage section for storing content information regarding particulars and a location of each content item stored in each dynamic peer and load information regarding a load on the dynamic peer;
a content information registration section for registering the content information received from the dynamic peer in the global storage section;
a load information registration section for registering, in the global storage section, the load information of the dynamic peer according to an operation status received from the dynamic peer; and
an information returning section for returning, in response to a request from a dynamic peer, the content information and the load information to the dynamic peer.

9. The center server according to claim 8, wherein:
the content information of a content item includes meta information regarding particulars of the content item and location information regarding a location of the content item;
the location information includes identification information regarding an identification of each peer having the content item stored therein and load information regarding a load on the peer.

10. The center server according to claim 8, wherein:
the load information registration section calculates the load information of a dynamic peer based on the operation status of the dynamic peer, and registers the calculated load information in the global storage section.

11. The center server according to claim 8, wherein in response to a request from a dynamic peer, the information returning section performs a search through the global storage section to retrieve content information and load information, so as to produce a content list including the retrieved content information and load information and send the produced content list to the dynamic peer.

12. A static peer connectable to a center server being connected to a plurality of dynamic peers, comprising:
a local storage section for storing a plurality of content items;
a section for registering a content item in the local storage section;
a section for sending content information of the registered content item to the center server;
a section for sending an operation status of the static peer to the center server; and
a section for uploading a desired content item to a requesting dynamic peer.

13. A peer-to-peer-type content distribution method, comprising the steps of:
registering, in a center server, content information regarding particulars and a location of each content item stored in each of a plurality of dynamic peers;
registering, in the center server, load information regarding a load on a dynamic peer according to an operation status sent from the dynamic peer;
returning, in response to a request from a dynamic peer, the content information and the load information from the center server to the dynamic peer;
selecting one or more sender peers, being one or more of the plurality of dynamic peers, having a desired content item stored therein based on the content information returned from the center server to the dynamic peer, and further selecting one sender peer, from among the selected one or more sender peers, based on the load information returned from the center server to dynamic peer;
downloading the desired content item from the selected sender peer to the dynamic peer;
registering the downloaded content item in the dynamic peer;
sending content information of the registered content item from the dynamic peer to the center server; and
sending an operation status of the dynamic peer to the center server.

14. The peer-to-peer-type content distribution method according to claim 13, further comprising the steps of:
registering a content item in a static peer;
sending content information of the registered content item from the static peer to the center server;
registering the content information sent from the static peer in the center server;
sending an operation status of the static peer from the static peer to the center server; and
registering, in the center server, load information regarding a load on the static peer according to the operation status sent from the static peer.

15. A computer program for use in a dynamic peer connectable to a center server being connected to one or more dynamic peers, wherein the computer program instructs the dynamic peer to perform the steps of:
obtaining, from the center server, content information regarding particulars and a location of each content item stored in each dynamic peer and load information regarding a load on the dynamic peer;
selecting one or more sender peers, being one or more of the one or more dynamic peers, having a desired content item stored therein based on the obtained content information, and further selecting one sender peer, from among the selected one or more sender peers, based on the obtained load information;
downloading the desired content item from the selected peer;
registering the downloaded content item in the dynamic peer;
sending content information of the registered content item to the center server;
sending an operation status of the dynamic peer to the center server; and
uploading a desired content item to other dynamic peers.
